(19) United States
(12) Patent Application Publication
(10) Pub. No.: US 2023/0331190 A1
(43) Pub. Date: Oct. 19, 2023

(54) Horizontally Movable and Vertically Aligned Windshield Wiper System

(71) Applicant: Kayla Bereal-Murray, Pasadena, CA (US)

(72) Inventor: Kayla Bereal-Murray, Pasadena, CA (US)

(21) Appl. No.: 18/296,487

(22) Filed: Apr. 6, 2023

Related U.S. Application Data
(60) Provisional application No. 63/330,922, filed on Apr. 14, 2022.

(51) Int. Cl. B60S 1/34; B60S 1/08

(52) U.S. Cl. CPC B60S 1/3404; B60S 1/0814; B60S 1/3415; B60S 1/3497; B60S 2001/3829

(57) ABSTRACT

The present invention relates to a novel wiper system comprising a wiper vertically aligned to the height of a windshield and configured to move horizontally along a pair of tracks positioned along a top edge and a bottom edge of the windshield. The wiper and the tracks have a thin profile, so as not to obstruct the view of a driver and to not leave any blind spots. The wiper is driven by drive units that are configured to actuate the actuators of the wiper system. A motor provides electric power to the drive unit. The wiper's speed can be controlled using operating means positioned inside the vehicle and nozzles are positioned on the wiper for spraying washing fluid on the windshield. The wiper system can be retrofitted and improves vision while driving, minimizes debris on the windshield, and ensures the driver can clearly see through the windshield.

### CROSS-REFERENCE TO RELATED APPLICATION

The present application claims priority to, and the benefit of, U.S. Provisional Application No. 63/330,922, which was filed on Apr. 14, 2022, and is incorporated herein by reference in its entirety.

### FIELD OF THE INVENTION

The present invention relates generally to the field of windshield wipers. More specifically, the present invention relates to a novel wiper system comprising a wiper vertically aligned to the height of the windshield and configured to move horizontally along opposing tracks or channels positioned along a top edge and a bottom edge of the windshield. The wiper's speed can be controlled and nozzles positioned on the wiper can spray washing fluid on the windshield. The wiper system improves vision while driving, minimizing debris on the windshield, and ensuring the driver can clearly see through the windshield. Accordingly, the present disclosure makes specific reference thereto. Nonetheless, it is to be appreciated that aspects of the present invention are also equally applicable to other like applications, devices, and methods of manufacture.

### BACKGROUND

By way of background, windshield wipers are power-operated devices for keeping a windshield clear of rain and other debris, and are in the form of an arm, typically with a rubber blade that moves in an arc. Conventionally, flat and hybrid wiper blades are used in vehicles and upon receiving power from a wiper motor of the vehicle, the blades pivot back and forth over the windshield, pushing water, other precipitation, or any other impediments to visibility, from its surface. Commonly, two wipers are used that move in parallel motion forming a pair of arcs across the windshield and a speed of motion can be adjusted by a user using a knob positioned inside the vehicle.

Most of the conventional automobile windshield wipers work on an inversion mechanism of Basic 4-Bar mechanism, which is analogous to Beam Engine mechanism. The inversion mechanism is configured to convert rotary motion of a motor to oscillatory motion, which is responsible for back-and-forth movement of wiper blades.

Use of oscillatory motion of two wiper blades can obstruct the vision of a driver. As a result, unclear vision due to the wipers motion is dangerous and may cause accidents. Also, in many cases, one of the wiper blades can malfunction which leads to a dirty portion of the windshield. Constantly cleaning the windshield surface can be frustrating and inconvenient. Further, current designs of wipers are not optimum and do not clean the whole windshield. Some blind spots such as at the corners of the windshield are left outside of the wiper blade path (i.e., arc-shaped path) which can lead to difficult viewing and messy windshields.

In non-use position, the wipers are positioned horizontally, preferably along the bottom of the windshield, which allow dirt, debris, snow and more to deposit on the wipers. In such cases, when wipers are operated, the windshield becomes messy and dirty and may require a user to manually clean the windshield.

Therefore, there exists a long-felt need in the art for an improved windshield wiper that does not cause vision obstruction. There is also a long-felt need in the art for improved windshield wipers that minimize debris, dirt, snow, and more on the windshield. Additionally, there is a long-felt need in the art for unique windshield wiper that does not follow the conventional arc-shaped motion for cleaning the windshield. Moreover, there is a long-felt need in the art for a windshield wiper that easily and effectively cleans a windshield. Further, there is a long-felt need in the art for a windshield wiper system that positions the wiper in a unique vertical position and not in conventional horizontal position when not in use. Furthermore, there is a long-felt need in the art for a windshield wiper that can accommodate any type of rubber for cleaning a windshield. Finally, there is a long-felt need in the art for a unique windshield wiper that improves vision while driving, minimizing debris on the windshield, and ensuring the driver can clearly see through the windshield even during operation of the wiper.

The subject matter disclosed and claimed herein, in one embodiment thereof, comprises a vehicular windshield wiper system including a wiper aligned vertically with the height of the windshield for wiping the windshield between the side edges along the total width of the windshield. The wiper system has a pair of opposing tracks along the top edge and the bottom edge of the windshield, wherein the wiper is configured to slide along the tracks for moving across the windshield between side edges thereof. The system has a pair of driving units for driving the wiper along the tracks wherein the driving units are driven by a motor. The wiper further includes a plurality of nozzles for spraying washing fluid on the windshield preferably in the direction in which the wiper moves allowing the wiper to effectively clean the windshield without leaving any blind spots. The wiper is thin in profile and the tracks are positioned such that a view of a driver driving a vehicle is not obstructed. The speed of the horizontal movement of the wiper may be adjusted using operating means such as a lever or push button positioned inside the vehicle in which the wiper system is mounted.

In this manner, the windshield wiper system of the present invention accomplishes all of the forgoing objectives and provides users with a unique windshield wiper that moves across the windshield without causing vision obstruction. The tracks positioned along the top and bottom of the windshield allows movement of the wiper. The speed of the wiper can be adjusted and a single wiper can clean the windshield ensuring minimum debris, dirt, snow and more.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicular windshield wiper system including a wiper aligned vertically with the height of the windshield. The wiper system has a track each along the top edge and bottom edge of the windshield wherein the wiper is configured to slide along the tracks for moving across the windshield between side edges thereof. The system has a pair of driving units for driving the wiper along the tracks wherein the driving units are driven by a motor. The wiper further includes a plurality of nozzles for spraying washing fluid on the windshield preferably in the direction in which the wiper moves allowing the wiper to effectively clean the windshield without leaving any blind spots. The wiper is thin in profile and the tracks are positioned such that view of a driver driving a vehicle in which the wiper system is mounted is not obstructed.

In yet another embodiment, a horizontally moving and vertically aligned windshield wiper is disclosed. The wiper is configured to be operated and controlled using an operating means positioned inside the vehicle. The wiper is positioned along a side edge of the windshield in a rest position and is configured to slide along a first channel positioned along the top edge of the windshield and along a second channel positioned along the bottom edge of the windshield. The wiper is slid along the channels by a pair of actuators which are driven by a plurality of drive units. The wiper has a plurality of telescoping pins along the length of a primary arm thereof for adjusting the length of the wiper to conform to varying distance between the top edge and bottom edge of the windshield.

In yet another embodiment, a method of effectively cleaning windshield glass of a vehicle is described. The method includes the steps of mounting a wiper on the windshield, the wiper is vertically aligned to the height of the windshield and is positioned along a side edge of the windshield in non-use or rest position, mounting a track each along a top edge and along a bottom edge of the windshield; sliding the vertically aligned wiper along the tracks to move between the side edges of the windshield; cleaning the windshield by a rubber blade of the wiper; spraying washing fluid from a plurality of nozzles positioned on the wiper; and returning the wiper to the rest position along the side edge of the windshield.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a windshield wiper system of the present invention mounted in vicinity of windshield glass of a vehicle in accordance with the disclosed architecture;

FIG. 2 illustrates an enlarged view of the wiper of the wiper system of the present invention in accordance with the disclosed architecture;

FIG. 3 illustrates a functional block diagram depicting working of the improved wiper system of the present invention in accordance with the disclosed architecture;

FIG. 4 illustrates a flow diagram depicting a process of operating the wiper system 100 of the present invention in accordance with the disclosed architecture; and

FIG. 5 illustrates a perspective view showing position of the wiper at the middle of the windshield glass while cleaning or wiping the glass in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved windshield wiper that does not cause vision obstruction. There is also a long-felt need in the art for improved windshield wipers that minimize debris, dirt, snow, and more on the windshield. Additionally, there is a long-felt need in the art for unique windshield wiper that does not follow the conventional arc-shaped motion of heretofore known wipers for cleaning the windshield. Moreover, there is a long-felt need in the art for a windshield wiper that easily and effectively cleans a windshield. Further, there is a long-felt need in the art for a windshield wiper system that positions the wiper in a unique vertical position and not in conventional horizontal position when not in use. Furthermore, there is a long-felt need in the art for a windshield wiper that can accommodate any type of rubber for cleaning a windshield. Finally, there is a long-felt need in the art for a unique windshield wiper that improves vision while driving, minimizing debris on the windshield, and ensuring the driver can clearly see through nearly the entire windshield even during operation of the wiper.

The present invention, in one exemplary embodiment, is a horizontally moving windshield wiper. The wiper is vertically aligned to the height of the windshield and is configured to be operated and controlled using an operating means positioned inside the vehicle. In a resting or unused position, the wiper is positioned along a side edge, preferably the side edge opposite to the driver seat of the windshield and is configured to slide horizontally along a first channel positioned along the top edge of the windshield and along a second channel positioned along the bottom edge of the windshield for touching and wiping the windshield glass. The wiper slides along the channels or tracks by a pair of actuators which are driven by a plurality of drive units. The wiper has a plurality of telescoping pins along the length of a primary arm thereof for adjusting the length of the wiper to conform to varying distance between the top edge and bottom edge of the windshield.

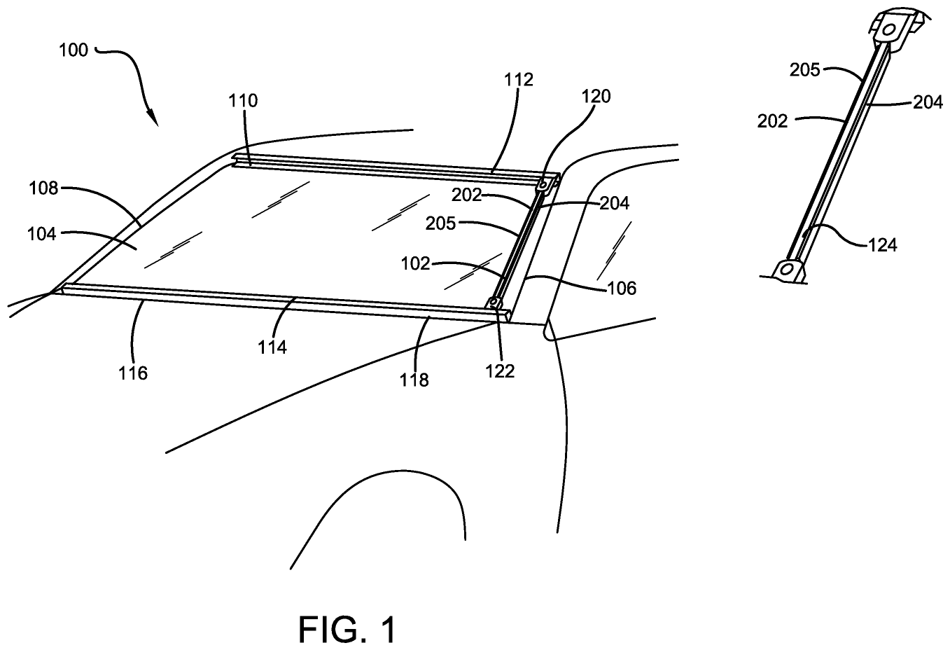

Referring initially to the drawings, FIG. 1 illustrates a perspective view of one potential embodiment of the windshield wiper system of the present invention mounted in vicinity of windshield glass of a vehicle in accordance with the disclosed architecture. The windshield wiper system 100 of the present invention is designed to enable a wiper assembly 102 move across the windshield 104 from a first side 106 to an opposing side 108 thereof. Unlike conventional arc-shaped movement of the windshield wipers, the wiper assembly 102 used in the present invention has horizontal movement. As a result, no portion of the windshield 104 is left dirty and messy (no blind spot) and all the dirt is moved to the sides 106, 108 of the windshield 104.

More specifically, a first track 110 is positioned along the top edge 112 of the windshield 104 and a second track 114 is positioned along the bottom edge 116 of the windshield 104 positioned in the cowl area 118 such that the tracks 110, 114 function as channels along which the wiper assembly 102 moves between the side edges 106, 108. When the wiper assembly 102 is not used, the wiper assembly 102 remains vertically aligned along one of the edges 106, 108, thereby eliminating deposits of dirt, dust, snow, ice, and more when the wiper assembly 102 is not used.

The wiper assembly 102 is coupled to the first track 110 using a first coupling actuator 120 and is coupled to the second track 114 using a second coupling actuator 122. The actuators or units 120, 122 move along the tracks 110, 114 respectively in a synchronized manner or motion for a smooth horizontal movement of the wiper assembly 102. The wiper assembly 102 has a plurality of washer fluid spray nozzles 124 for spraying washer fluid on the windshield glass 102 that can be used by the wiper assembly 102 for effectively cleaning the windshield glass 104. The nozzles 124 spray the fluid on the windshield 104 in a horizontal direction in the direction of the movement of the wiper assembly 102.

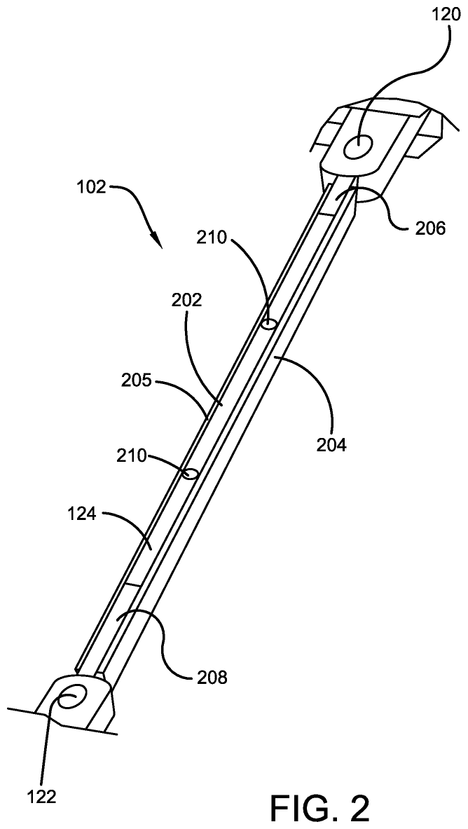

In some embodiments of the present invention, the wiper assembly 102 is telescoping in construction allowing the wiper assembly 102 to adjust a length thereof in cases where the distance between the edges 112, 116 is non-uniform depending on design and shape of the windshield 104. The wiper assembly 102 is powered by a drive unit or wiper motor as described in FIG. 2 which is configured to actuate coupling actuators 120, 122 using the internal electric power of the vehicle in which the wiper system 100 is installed.

FIG. 2 illustrates an enlarged view of the wiper assembly 102 of the wiper system 100 of the present invention in accordance with the disclosed architecture. The wiper assembly 102 has a wiper primary arm 202 that can be elongated or slightly bent similar to conventional windshield wiper arms. Auxiliary wiper rubber arms 204, 205 are attached to the primary arm 202 such that the rubber arms 204, 205 contact and wipe the windshield 102, thereby preventing scratches on the windshield while maintaining a clean glass area. The rubber arms or blades 204, 205 can be molded from a wide variety of elastomers including natural and synthetic rubbers, such as natural or synthetic polyisoprene, butadiene, ethylene-propylene-diene rubber, neoprene, or blends thereof. Both the rubber arms or blades 204, 205 are thin in profile and do not break down from extreme weather conditions, dust, and dirt.

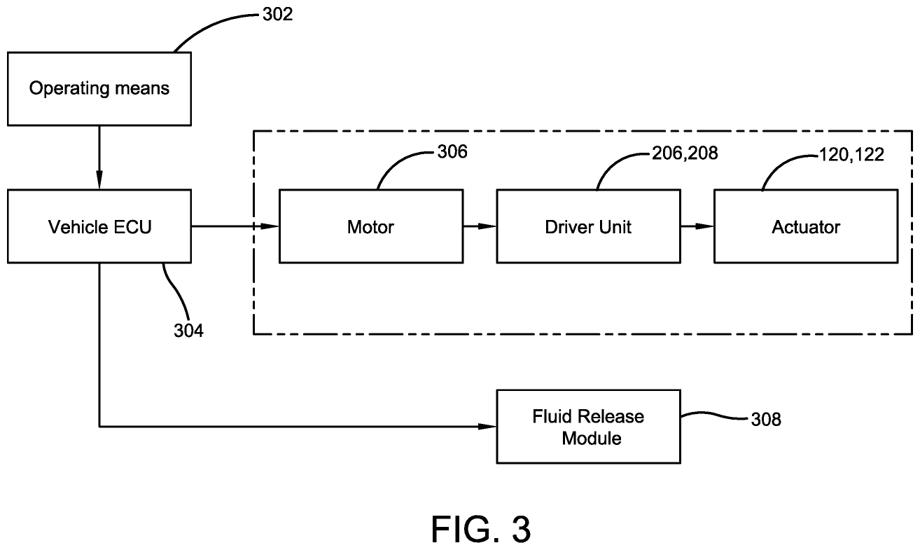

A plurality of fluid spraying nozzles 124 are preferably positioned on the primary arm 202 and may receive fluid from a reservoir (not shown) positioned in the vehicle. For driving the wiper assembly 102 along the tracks 110, 114, a first drive unit 206 is coupled to the actuator 120 and a second drive unit 208 is coupled to the second actuator 122. The drive units 206, 208 are configured to receive drive power from a motor as described in FIG. 3. The drive units 206, 208 actuate the actuators 120, 122 respectively allowing the wiper assembly 102 to smoothly move horizontally across the windshield along the channels 110, 114.

For automatically adjusting a length of the primary arm 202, a plurality of telescoping points 210 are positioned thereon, that can adjust the length of the wiper arm 202. It should be noted that the adjustment in length may be programmed depending on size of the windshield of the vehicle in which the wiper system 100 of the present invention is installed.

FIG. 3 illustrates a functional block diagram depicting working of the improved wiper system of the present invention in accordance with the disclosed architecture. The wiper system 100 installed in the vicinity of windshield glass of a vehicle is operable using one or more operating means 302 positioned inside the vehicle. The operating means 302 can be a lever arm or one or more control buttons positioned on a dashboard of the vehicle. Further, the operating means 302 is also configured to adjust speed of movement of the wiper assembly 102 along the channels 110, 114.

The operating means 302 instructs the vehicle's electronic control unit (ECU) 304 for providing electric power to a motor 306 that is configured to drive the driver units 206, 208 of the wiper assembly 102. The motor 306 is a specialized motor that is configured not to produce oscillatory motion like that in conventional windshield wiper systems. The driver units 206, 208 actuate the actuators or units 120, 122 as discussed earlier for achieving a linear motion along the top and bottom tracks/channels. The wiper motor 306 features a high-speed brush, a low-speed brush, and a common brush that can be used for both low speed and high speed. Thus, the wiper motor 306 is capable of operating in a high-speed mode in which the wiper assembly 102 is operated at a high speed, and a low-speed mode in which the wiper assembly 102 is operated at a low speed.

In some embodiments, the special operating means 302 is designed to operate the wiper system 100 or alternatively, the existing lever arm of the wiper system may be used to operate and control the wiper system 100. For releasing fluid from the nozzles positioned on the wiper arm 202, the ECU 304 activates a fluid release module 308. The module 308 is in the form of a pump and can be coupled to the nozzles for releasing the fluid upon control of the operating means 302.

The nozzles 124 may have a jet type spray nozzle for spraying the washer fluid linearly, or a mist type spray nozzle for spraying the washer fluid in a misting manner.

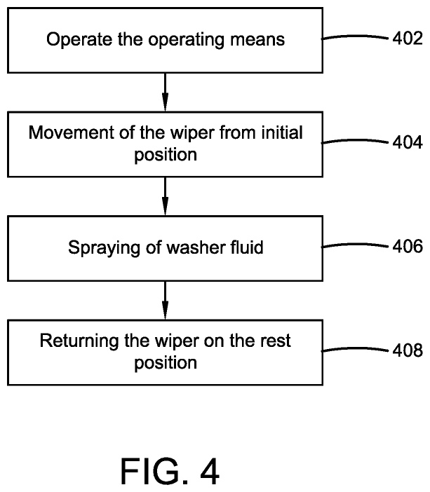

FIG. 4 illustrates a flow diagram depicting a process of operating the wiper system 100 of the present invention in accordance with the disclosed architecture. At step 402, the wiper system for cleaning windshield glass is operated using the operating means such as a lever or push or touch button positioned inside the vehicle. At step 404, the driver units horizontally move the wiper along the channels positioned on the top and bottom edges of the windshield.

At step 406, as per requirement a user of the vehicle, the washing fluid is sprayed on the windshield glass from the nozzles positioned on the primary arm. Finally, at step 408, when use of the wiper system is finished, the wiper is positioned at its initial or rest position, preferably along a side edge of the windshield positioned on the opposite side of the steering of the vehicle. A switch or the motor of the system 100 is configured to bring the wiper assembly 102 to the rest position when operation of the system 100 is turned off.

The wiper system 100 of the present invention can be integrated into a new vehicle during manufacturing of the vehicle or can be retrofitted as an aftermarket product in existing vehicles. The rubber blade can be removed and replaced wherein the wiper assembly 102 is thin in profile and made of thin, water-resistant material.

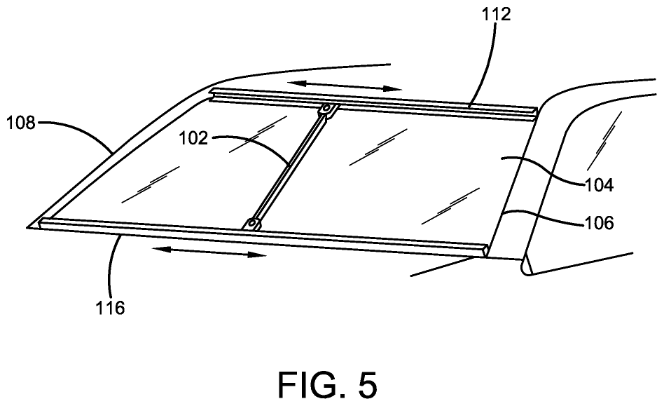

FIG. 5 illustrates a perspective view showing position of the wiper assembly 102 at the middle of the windshield glass while cleaning or wiping the glass in accordance with the disclosed architecture. The length of the wiper assembly 102 is adjusted to wipe the glass 104 from the top edge 112 to the bottom edge 116 and wiper assembly 102 moves horizontally between the side edges 106, 108 such that no blind spot is left behind on the windshield 104. Further, during movement of the wiper assembly 102, the wiper rubber blade 204 remains in contact with the glass 104 irrespective of curvature of the glass 104, thereby ensuring a clean windshield 104. The wiper assembly 102 being thin in profile does not obstruct view of a driver while driving the vehicle and the wiper assembly 102 always remains vertical during movement on the windshield 104.

In the wiper arm according to the present invention, orientations of the nozzles are specified so as to spray the washing fluid in the direction of motion of the wiper assembly 102 or in mutually opposing directions with respect to the wiper assembly 102.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “wiper system”, “improved wiper system”, “windshield wiper system”, and “unobstructive windshield wiper system” are interchangeable and refer to the unobstructive viewing windshield wiper system 100 of the present invention.

Notwithstanding the forgoing, the unobstructive viewing windshield wiper system 100 of the present invention can be of any suitable size and configuration as is known in the art without affecting the overall concept of the invention, provided that it accomplishes the above-stated objectives. One of ordinary skill in the art will appreciate that the unobstructive viewing windshield wiper system 100 as shown in the FIGS. are for illustrative purposes only, and that many other sizes and shapes of the unobstructive viewing windshield wiper system 100 are well within the scope of the present disclosure. Although the dimensions of the unobstructive viewing windshield wiper system 100 are important design parameters for user convenience, the unobstructive viewing windshield wiper system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A windshield wiper system comprising:
a wiper assembly;
a wiper motor;
a first track; and
a second track;
wherein said wiper assembly having a pair of actuator units, a wiper arm, and a first wiper blade;
wherein said first track positioned along a top edge of a windshield and said second track positioned along a bottom edge of the windshield;
wherein said wiper assembly oriented vertically and mounted between said first track and said second track; and
further wherein said wiper assembly actuated to move said wiper arm and said first wiper blade horizontally along said first track and said second track from a first side of the windshield to a second opposing side of the windshield.

2. The windshield wiper system of claim 1, wherein said second track is positioned in a cowl area of the windshield.

3. The windshield wiper system of claim 1, wherein said wiper assembly having a first actuator unit coupled to said first track and a second actuator unit coupled to said second track;
wherein said first actuator unit and said second actuator unit powered by said wiper motor of the vehicle; and
further wherein said first actuator unit moves along said first track and said second actuator unit moves along said second track in a synchronized motion.

4. The windshield wiper system of claim 1, wherein said wiper assembly further comprises a plurality of washer fluid spray nozzles for spraying washer fluid on the windshield glass.

5. The windshield wiper system of claim 4, wherein said washer fluid spray nozzles spray washer fluid in a horizontal direction when said wiper assembly is moved across the windshield.

6. The windshield wiper system of claim 5, wherein said wiper arm having a telescoping arm for allowing said wiper assembly to adjust a length between said first track and said second track.

7. The windshield wiper system of claim 6, wherein said wiper assembly having a second wiper blade; and
further wherein said first wiper blade and said second wiper blade having a material selected from a group consisting of a natural polyisoprene, a synthetic polyisoprene, a butadiene, an ethylene-propylene-diene rubber, and a neoprene.

8. A windshield wiper system comprising:
a wiper assembly;
a wiper motor;
a first track; and
a second track;
wherein said wiper assembly having a pair of actuator units, a wiper arm, and a wiper blade;
wherein said first track positioned along a top edge of a windshield and said second track positioned along a bottom edge of the windshield;
wherein said wiper assembly oriented vertically and mounted between said first track and said second track;
wherein said wiper assembly actuated to move said wiper arm and said wiper blade horizontally along said first track and said second track from a first side of the windshield to a second opposing side of the windshield; and
further wherein said wiper arm having a telescoping arm for allowing said wiper assembly to adjust a length between said first track and said second track.

9. The windshield wiper system of claim 8, wherein said second track is positioned in a cowl area of the windshield.

10. The windshield wiper system of claim 9, wherein said wiper assembly having a first actuator unit coupled to said first track and a second actuator unit coupled to said second track;
wherein said first actuator unit and said second actuator unit powered by said wiper motor of the vehicle; and
further wherein said first actuator unit moves along said first track and said second actuator unit moves along said second track in a synchronized motion.

11. The windshield wiper system of claim 10, wherein said wiper assembly further comprising a plurality of washer fluid spray nozzles for spraying washer fluid on the windshield glass.

12. The windshield wiper system of claim 11, wherein said washer fluid spray nozzles spray washer fluid in a horizontal direction when said wiper assembly is moved across the windshield.

13. The windshield wiper system of claim 12, wherein said wiper blade having a material selected from a group consisting of a natural polyisoprene, a synthetic polyisoprene, a butadiene, an ethylene-propylene-diene rubber, and a neoprene.

14. A windshield wiper system comprising:
a wiper assembly;
a wiper motor;
a first track; and
a second track;
wherein said wiper assembly having a pair of actuator units, a wiper arm, and a wiper blade;
wherein said first track positioned along a top edge of a windshield and said second track positioned along a bottom edge of the windshield;
wherein said wiper assembly actuated to move said wiper arm and said wiper blade horizontally along said first track and said second track from a first side of the windshield to a second opposing side of the windshield;
wherein said wiper arm having a telescoping arm for allowing said wiper assembly to adjust a length between said first track and said second track; and
further wherein said wiper motor having a high-speed brush, a low-speed brush, and a common brush for selectively controlling a speed of said wiper arm.

15. The windshield wiper system of claim 14, wherein said wiper assembly oriented vertically and mounted between said first track and said second track.

16. The windshield wiper system of claim 14, wherein said second track is positioned in a cowl area of the windshield.

17. The windshield wiper system of claim 14, wherein said wiper assembly having a first actuator unit coupled to said first track and a second actuator unit coupled to said second track;
wherein said first actuator unit and said second actuator unit powered by said wiper motor of the vehicle; and
further wherein said first actuator unit moves along said first track and said second actuator unit moves along said second track in a synchronized motion.

18. The windshield wiper system of claim 14, wherein said wiper assembly further comprising a plurality of washer fluid spray nozzles for spraying washer fluid on the windshield glass.

19. The windshield wiper system of claim 18, wherein said washer fluid spray nozzles spray washer fluid in a horizontal direction when said wiper assembly is moved across the windshield.

20. The windshield wiper system of claim 14, wherein said wiper blade having a material selected from a group consisting of a natural polyisoprene, a synthetic polyisoprene, a butadiene, an ethylene-propylene-diene rubber, and a neoprene.
